(19) United States
(12) Patent Application Publication
(10) Pub. No.: US 2014/0054490 A1
(43) Pub. Date: Feb. 27, 2014

(54) GRAPHENE COMPOSITES WITH DISPERSED METAL OR METAL OXIDE

(71) Applicant: INDIAN INSTITUTE OF TECHNOLOGY MADRAS, Tamilnadu (IN)

(72) Inventors: Ramaprabhu SUNDARA, Chennai (IN); Eswaraiah VARRLA, Kurnool (IN); Jyothirmayee Aravind SASIDHARANNAIR SASIKALADEVI, Trivandrum (IN)

(73) Assignee: INDIAN INSTITUTE OF TECHNOLOGY MADRAS, Tamilnadu (IN)

(21) Appl. No.: 13/956,807

(22) Filed: Aug. 1, 2013

(30) Foreign Application Priority Data
Aug. 25, 2012 (IN) 3506/CHE/2012

(51) Int. Cl. H01B 1/02; H01B 1/04

(52) U.S. Cl. CPC H01B 1/02; H01B 1/04
USPC 252/62.56; 252/503; 252/506

(57) ABSTRACT

Metal-graphene nanocomposites, metal-oxide-graphene nanocomposites, and method for their preparation are described. According to some embodiments, a metal salt is combined with graphite oxide (GO) to form a metal salt-GO composite. The metal salt-GO composite is reduced to a metal-graphene or metal oxide-graphene nanocomposite material. The metals may be magnetic or non-magnetic. In some embodiments, the reduction is conducted via exposure to intensified electromagnetic radiation, such as focused solar radiation.

### CROSS-REFERENCE TO RELATED APPLICATIONS

This application is a US non-provisional application that claims the benefit of Indian Patent Application No. 3506/CHE/2012, filed on Aug. 25, 2012, the entire contents of which are incorporated herein by reference in its entirety.

### BACKGROUND

The distinctive electronic, thermal and mechanical properties of graphene make it a potentially useful technology across a variety of industries. Efficient exfoliation of graphene oxide (GO) by focused solar radiation has been reported (in a previous study by the inventors herein). Graphene sheets, which possess unique nanostructure, are promising nanoscale building blocks of new composites, such as a promising support material for the dispersion of nanoparticles for various applications.

Aggregation of isolated metal/metal oxide graphene sheets prepared by a chemical route typically leads to a loss of its high aspect ratio as a 2D material. Generally, functionalization with acids/polar reagents is necessary to make the synthesized graphene suitable for the deposition of metal/metal oxide nanoparticles. This functionalization process can create defects which will depreciate the properties of grown graphene. Like other dispersions of nanomaterials with high aspect ratios, upon drying the graphene dispersion, isolated sheets aggregate and form irreversibly precipitated agglomerates due to van der Waals attraction. In other words, if one follows the chemical processes for functionalization and/or metal coating over graphene, the properties of graphene rapidly decline with the number of aggregated sheets, approaching its 3D limiting form, graphite.

Methods for maintaining the high aspect ratio as a 2D material on needed as one more methods for preparing graphene composites with dispense metal or metal oxides.

### SUMMARY

Some embodiments provide methods of making a metal/metal oxide nanoparticle dispersed graphene nanocomposite, the method comprising: providing a substantially solid metal salt-graphite oxide composite; and exposing the metal salt-graphite oxide composite to intensified electromagnetic radiation to form the metal/metal oxide nanoparticles dispersed graphene nanocomposite by reducing the metal salt to a metal or metal oxide and the graphite oxide to graphene.

In some embodiments, the electromagnetic radiation is selected from visible light, sunlight, simulated sunlight, a combination thereof, a selected portion thereof, or a combination of selected portions thereof to suitable power (1-3 W and even more) and sufficient temperature (300-400° C. and more with high focal length converging lenses).

In some embodiments, the metal salt-graphite oxide composite comprises a metal salt selected from iron salts, copper salts, nickel salts, gold salts, silver salts, platinum salts, palladium salts, cobalt salts, tin, aluminium, manganese, chromium, zinc, cerium and ruthenium salts, and combinations thereof.

In some embodiments, the metal salt-graphite oxide composite comprises a metal salt selected from FeCl₂, CuCl₂, CoCl₂, NiCl₂, AgCl, HAuCl₂, HAuCl₄, AgNO₃, H₂PtCl₆, H₂PdCl₄, RuCl₂, Co(NO₃)₂, AgC₂H₃O₂, CuSO₄, FeSO₄, SnCl₂, ZnCl₂, (NH₄)₂Ce(NO₃)₆, CrCl₃, metal acetates and combinations thereof.

Some embodiments provide nanocomposites comprising a graphene sheet; and a plurality of nanoparticles of at least one metal or metal oxide dispersed on the graphene sheet.

### BRIEF DESCRIPTION OF THE DRAWINGS

The drawings submitted herewith show some embodiments or features of some embodiments encompassed by the disclosure. The drawings are meant to be illustrative and are not intended to be limiting. Like reference numeral refer to like elements through the drawings.

FIG. 1a is an X-Ray Diffraction (XRD) spectrum comparing graphite oxide (GO) to its reduced form, graphene, here indicated as sG.

FIG. 1b an X-Ray Diffraction (XRD) spectrum comparing gold chloride to its reduced metal form —Au-sG nanocomposite.

FIG. 1c an X-Ray Diffraction (XRD) spectrum comparing copper chloride to its reduced metal oxide form —CuO-sG nanocomposite.

FIG. 1d is an enlarged X-Ray Diffraction (XRD) spectrum comparing copper chloride to its reduced metal oxide form —CuO-sG nanocomposite.

FIG. 1e an X-Ray Diffraction (XRD) spectrum comparing nickel chloride to its reduced metal oxide form —NiO-sG nanocomposite.

FIG. 1f an X-Ray Diffraction (XRD) spectrum comparing nickel chloride to its reduced metal oxide form —NiO-sG nanocomposite.

FIG. 1g an X-Ray Diffraction (XRD) spectrum comparing iron chloride to its reduced metal oxide form —Fe₂O₃-sG nanocomposite.

FIG. 1 h an X-Ray Diffraction (XRD) spectrum comparing silver chloride to its reduced metal oxide form —Ag-sG nanocomposite.

FIG. 2a is an FESEM image of graphite oxide.

FIG. 2 is an FESEM image of metal salt, CuCl₂.

FIG. 2c is an FESEM image of metal salt, NiCl₂.

FIG. 2d is an FESEM image of metal salt, HAuCl₂.

FIG. 2e is an FESEM image of metal salt, FeCl₂.

FIG. 2f is an FESEM image of metal salt, AgCl.

FIG. 3a is an FESEM image of graphene.

FIG. 3b is an FESEM image of a CuO-graphene nanocomposite in accordance with some embodiments.

FIG. 3c is an FESEM image of a NiO-graphene nanocomposite in accordance with some embodiments.

FIG. 3d is an FESEM image of an Au-graphene nanocomposite in accordance with some embodiments.

FIG. 3e is an FESEM image of a Fe₂O₃-graphene nanocomposite in accordance with some embodiments.

FIG. 3f is an FESEM image of an Ag-graphene nanocomposite in accordance with some embodiments.

FIG. 4 is a graph depicting a thermogravimetric analysis (TGA) of NiCl₂ compared to NiO-sG nanocomposite.

### DETAILED DESCRIPTION

Adhering metal nanoparticles to substantially two-dimensional graphene sheets by a solution-free route could inhibit the aggregation of graphene sheets and result in mechanically tight, exfoliated graphene nanosheets. Graphene with dispersed magnetic/non-magnetic-metal and metal oxide nanoparticles can be synthesized by a simple and green solution-free, route in a single step. Intensified electromagnetic radiation is employed to reduce different insulating metal salts and graphite oxide (GO) simultaneously in a single step to synthesize conducting and semiconducting metal/metal oxide dispersed graphene nanocomposites.

For example, a hybrid nano structure of graphene dispersed with different metals (e.g. Au, Ag, Pt, Pd, Ru) and metal oxides (e.g. NiO, CuO, Fe₂O₃, CoO) nanoparticles can be made using a solar exfoliation technique (e.g. using focused solar radiation). Insulating precursors (metal salts and GO) can be simultaneously reduced into conducting and semiconducting metal/metal oxide dispersed graphene composites by this simple technique. High resolution scanning electron microscope (HRSEM) analysis along with Energy Dispersive X-ray analysis (EDX), powder X-ray diffractograms (XRD) and thermal gravimetric analyses (TGA) confirm the simultaneous reduction of metal salts and GO and the formation of hybrid nanocomposites.

Conventional preparation of metals and metal loaded composites typically involve reduction via chemical reducing agents. In some embodiments described herein, the base material (graphene) need not be functionalized while preparing metal/metal oxide/graphene composites. Moreover, metal/metal oxide dispersed graphene composites can be prepared in a single step by the present approach.

Some embodiments employ simultaneous reduction of metal salts and graphite oxide (GO) by focused solar radiation for the preparation of metal/metal oxide dispersed graphene nanocomposites.

Some embodiments provide for reduction of GO by techniques using solar energy, particularly focused solar energy. Throughout the application, reference to sG indicates “solar graphene”, a term used to indicate graphene made using solar energy.

Some embodiments allow for ultra-fast preparation (10 minutes for metal salt to salt reduction and 5-10 minutes for co-reduction of metal salt/graphite oxide into metal/metal oxide/graphene composites) of metal/metal oxide/graphene nanocomposites stands above all existing methods.

The present technique is economic and mass production can be easily achieved.

The proposed process is a green process: there are no harmful chemicals involved.

When focused solar energy is used for materials synthesis the entire process saves electricity, time and reduces man power and may be industrialized easily.

Some embodiments provide a method of making a metal/metal oxide nanoparticle dispersed graphene nanocomposite, the method comprising: providing a substantially solid metal salt-graphite oxide composite; and exposing the metal salt-graphite oxide composite to intensified electromagnetic radiation to form the metal/metal oxide nanoparticles dispersed graphene nanocomposite by reducing the metal salt to a metal or metal oxide and the graphite oxide to graphene.

The substantially solid metal salt-graphite oxide composite comprises graphite oxide and metal salt. “Substantially solid” means the composite is not a liquid or semi-liquid, and, in some embodiments, may contain up to about 10% solvent.

Although the graphite oxide used can be from any available source or made by any appropriate method, in some embodiments, the graphite oxide can be prepared by Hummers method.

The metal salt employed to make the composite may be any suitable metal salt and may include either a metallic or a non-metallic metal. Exemplary metal salts include are not limited to those selected from iron salts, copper salts, nickel salts, gold salts, silver salts, platinum salts, palladium salts, cobalt salts, zinc salts, cerium salts, ruthenium salts, tin salts, chromium salts, and combinations thereof. Further exemplary metal salts include, but are not limited to metal salt selected from halide salts, sulphate salts, acetate salts, and nitrate salts of iron, copper, nickel, gold, silver, platinum, palladium, cobalt, ruthenium and combinations thereof. Additionally, exemplary metal salts include, but are not limited to, a metal salt selected from FeCl₂, CuCl₂, CoCl₂, NiCl₂, AgCl, HAuCl₂, HAuCl₄, AgNO₃, H₂PtCl₆, H₂PdCl₄, RuCl₂, Co(NO₃)₂, AgC₂H₃O₂, CuSO₄, FeSO₄, SnCl₂, ZnCl₂, (NH₄)₂Ce(NO₃)₆, CrCl₃, metal acetates, and combinations thereof.

Although any electromagnetic radiation may be used, the inventors particularly contemplate the use of light energy, and particularly solar energy. In some embodiments, the electromagnetic radiation is selected from visible light, sunlight, simulated sunlight, a combination thereof, a selected portion thereof, or a combination of selected portions thereof.

In some embodiments, the intensified electromagnetic radiation is provided by a) passing electromagnetic radiation through at least one refractile material, b) passing the electromagnetic radiation through at least one converging lens, c) reflecting the electromagnetic radiation off of one or more converging mirrors, or combination thereof. In so doing, an intensified power of about 0.5 Watt/cm² to about 3 Watts/cm², about 1 Watt/cm² to about 3 Watt/cm² (and even more) and sufficient temperature of about 300° C. to about 400° C. and more can be achieved. In some embodiments, about 0.65 Watt/cm² to about 1.95 Watts/cm² are generated. In some instances, the power can be intensified by any suitable means, such as, but not limited to focusing with one or more converging lenses, such as a high focal length converging lens. In some embodiments, the intensified electromagnetic radiation increases the temperature of the metal salt-graphite oxide composite to the sufficient temperature at a rate of about 75° C. per second to about 200° C. per second. In some embodiments, the temperature increase is about 150° C. to about 200° C. in about 1 second to about 2 seconds.

Once exposed to the intensified electromagnetic radiation, the metal salt-GO composite is reduced. The metal salt reduces, depending on the salt, to a metal or a metal oxide, while the GO reduces to graphene. The exposure (i.e. reduction) time depends on factors such as amount of sample taken, intensity of EM radiation, the focal length of the lens, etc. For example, 100 mg of metal salt/GO composite can be reduced/exfoliated using intense sunlight in less than 10 minutes.

The reduction of the metal salt and Graphite Oxide, can be shown by measuring the chlorine content in metal salts containing chlorine compared to the chlorine content in the resultant metal/metal oxide nanoparticles decorated graphene.

The chlorine content in chloride based metal salt-graphite oxide composites ranges from about 40-78% in NiCl₂, AuCl₃, CuCl₂, FeCl₂, AgCl in GO composites whereas the chlorine content in reduced metal/metal oxide graphene nanocomposites are less than about 2% evidencing the reduction. The chlorine appears to be liberated as chlorine gas and as evidenced by observation of a pungent chlorine smell. The oxygen content in metal salt/GO composites is about 30-40% whereas in the case of reduced metal/graphene and metal oxide/graphene nano composites, it is less than about 7% and less than about 15% respectively, evidencing the reduction, the metal salt-GO composites show sudden weight losses at low temperatures in thermogravimetric analysis whereas metal/metal oxide graphene nanosheets do not show abrupt weight loss.

Although the substantially solid metal salt-graphite oxide composite may be prepared by any suitable means, in some embodiments, the substantially solid metal salt-graphite oxide composite maybe prepared by: dispersing graphite oxide in a solvent to form a dispersion; adding a metal salt to the dispersion; and drying the resultant material to yield a substantially solid metal salt-graphite oxide composite.

To aid in dispersing the graphite oxide in the solvent the dispersing step may further comprise dispersing the graphite oxide in the solvent by ultrasonication.

In some embodiments, the solvent is selected from water, dimethyl formamide, acetone, DMF, THF, DMSO and combinations thereof. In some embodiments, the solvent comprises water. In some embodiments, the metal salt may also be in solution.

As noted above, any suitable metal salt may be used, particularly, however, some suitable salts include metal salts selected from FeCl₂, CuCl₂, CoCl₂, NiCl₂, AgCl, HAuCl₂, HAuCl₄, AgNO₃, H₂PtCl₆, H₂PdCl₄, RuCl₂, Co(NO₃)₂, AgC₂H₃O₂, CuSO₄, FeSO₄, SnCl₂, ZnCl₂, (NH₄)₂Ce(NO₃)₆, CrCl₃, metal acetates and combinations thereof.

During the exposing step, the metal salt and the graphite oxide are simultaneously reduced. The metal salt is reduced, depending on the salt, to a metal or a metal oxide. The graphite oxide is reduced to graphene. The result is nano composite material comprising a graphene sheet and nanoparticles of the metal or metal oxide.

In some instances, the metal salt is reduced to its corresponding metal. For example, when the metal salt-graphite oxide composite comprises a metal salt selected from AgCl, HAuCl₄, HAuCl₂, HAuCl₄, AgNO₃, H₂PtCl₆, H₂PdCl₄, RuCl₂, SnCl₂, ZnCl₂, (NH₄)₂Ce(NO₃)₆, CrCl₃, or metal acetates it is reduced to its corresponding metal selected from Ag, Au, Pt, Pd, Ru, Sn, Ce and Cr.

In other cases, the metal salt is reduced to its corresponding metal oxide. For example, when the metal salt-graphite oxide composite comprises a metal salt selected from FeCl₂, CuCl₂, CoCl₂ NiCl₂, SnCl₂, ZnCl₂, (NH₄)₂Ce(NO₃)₆, and CrCl₃, it is reduced to its corresponding metal oxide selected from Fe₂O₃, CuO, CoO, NiO, SnO₂, ZnO, CeO₂, and CrO₂.

With these methods, a nanocomposite comprising a graphene sheet and a dispersed metal or metal oxide can be formed. In some embodiments, such a nanocomposite comprises a graphene sheet; and a plurality of nanoparticles of at least one metal or metal oxide dispersed on the graphene sheet.

As noted above, the resultant nanocomposite may comprise either a metal or metal oxide resulting from the reduction of the metal salt, as listed above. In some embodiments, the nanocomposite comprises at least one metal or metal oxide selected from Fe₂O₃, CuO, NiO, Au, Ag, Pt, Pd, Co, Ru, CoO, RuO₂, ZnO, SnO₂, CeO₂, CrO₂, and combinations thereof. In some embodiments, the at least one metal or metal oxide is a metal oxide. In some embodiments, the metal oxide is selected from Fe₂O₃, CuO, NiO, CoO, RuO₂, CeO₂, CrO₂, ZnO and SnO₂ and combinations thereof.

In some embodiments, the at least one metal or metal oxide is a metal. In some embodiments, the metal is selected from Au, Ag, Pt, Pd, Co, Ru, and combinations thereof.

As will be appreciated, graphene is produced as a sheet material. As such, each graphene sheet defines two sides (faces) and the nanoparticles of the at least one metal or metal oxide maybe dispersed substantially evenly on both sides of the graphene sheet. Those of skill in the art will recognize that a graphene sheet may be a single layer or multiple layers, and may vary from single to multiple layers in a single sheet, provided that it retains its two dimensional qualities, rather than three dimensional qualities associated with graphite. In some embodiments, the graphene nanocomposite material may have lateral dimensions of about 1 μm and thickness varying from about 1 nm to about 10 nm. The dispersed nanoparticles may form a coating on one or both sides of the graphene sheet may be interposed between two layers of a multilayer sheet, or a combination thereof. The graphene sheet may be coated by metal or metal oxide nanoparticles distributed throughout the sheets. In some embodiments, the nanocomposite comprises a plurality of graphene sheets, each of which contains dispersed nanoparticles of at least one metal or metal oxide.

In some embodiments, the nanoparticles may be either non-magnetic or magnetic nanoparticles or combinations of thereof.

The dispersed metal or metal oxide nanoparticles may have a diameter of about 5-50 nm and may form a single layer coating the graphene sheet. For example, a graphene sheet can be coated with any of about 10-15 nm Ag nanoparticles distributed over the graphene sheets with face centered cubic structure of Ag, about 12-18 nm Au nanoparticles with face centered cubic structure, about 12-20 nm CuO nanoparticles, about 9-18 nm NiO nanoparticles, or about 34-50 nm magnetic Fe₂O₃ (red oxide) nanoparticles.

### EXAMPLES

### Example 1

### Synthesis of Metal Salt/GO Composites

Graphite oxide prepared by modified Hummer's method and 100 mg of GO was dispersed in 20 ml of de-ionized water by ultrasonication for 20 minutes. A metal salt solution in deionized water was added into the graphite oxide dispersion and stirred for a period of 1 hour. The solution was dried off to obtain solid composite of metal salt/GO. See Table 1, below for exemplary metal salts and amounts used.

### Example 2

### Reduction of Metal Salt/GO Composite

Solar exfoliation of the metal salt/GO composite was carried out using a convex lens of 100 mm diameter to focus solar energy on the metal salt/GO composite of Example 1. The metal salt/GO composite was exposed to the focused solar energy for less than about 10 minutes per 100 mg. The as synthesized metal/metal oxide/solar graphene (G) composite was used for analyses without further treatment.

The table below illustrates metal salt-GO composites made in accordance with Example 1, and the resultant reduced form nanocomposite graphene of Example 2.

| Metal Salt (mg) | mg GO | Metal Salt-GO composite | Reduced Form |
|---|---|---|---|
| HAuCl₃ (about 12 mg) | about 180 mg | HAuCl₃-GO (about 192 mg) | about 60 Au-G |
| CuCl₂ (about 36 mg) | about 180 mg | CuCl₂-GO (about 215 mg) | about 80 CuO-G |
| NiCl₂ (about 55 mg) | about 180 mg | NiCl₂-GO (235 mg) | about 80 NiO-G |
| FeCl₂ (about 40 mg) | about 180 mg | FeCl₂-GO (220 mg) | about 80 Fe₂O₃-G |
| AgCl (about 18 mg) | about 180 mg | AgCl-GO (about 198 mg) | about 63 Ag-G |

For comparison pure metal salts also were reduced using focused solar radiation in order to confirm the reduction of metal salts by solar radiation. During treatment with the focused solar radiation, a “popping” noise was heard, and a significant color difference was observed between the salts before and after reduction. The cyan, green and pale yellow colours of the salts of Cu, Ni and Fe changed to dark in color after being exposed to focused solar radiation for a few minutes. XRD, FESEM and EDX analyses of the reduced pure nanoparticles as well as metal/metal oxide dispersed graphene samples have been carried out in order to confirm the reduction process.

The starting iron salt, FeCl₂ as well as the FeCl₂/GO composite are not significantly magnetic. On the other hand, the reduced form, Fe₂O₃, and the Fe₂O₃-graphene nanocomposite are strongly magnetic. In the samples tested, the strong attraction of the entire group of nanoparticles towards the magnet indicates the complete reduction of FeCl₂ to Fe₂O₃ as well as FeCl₂/GO to Fe₂O₃/graphene.

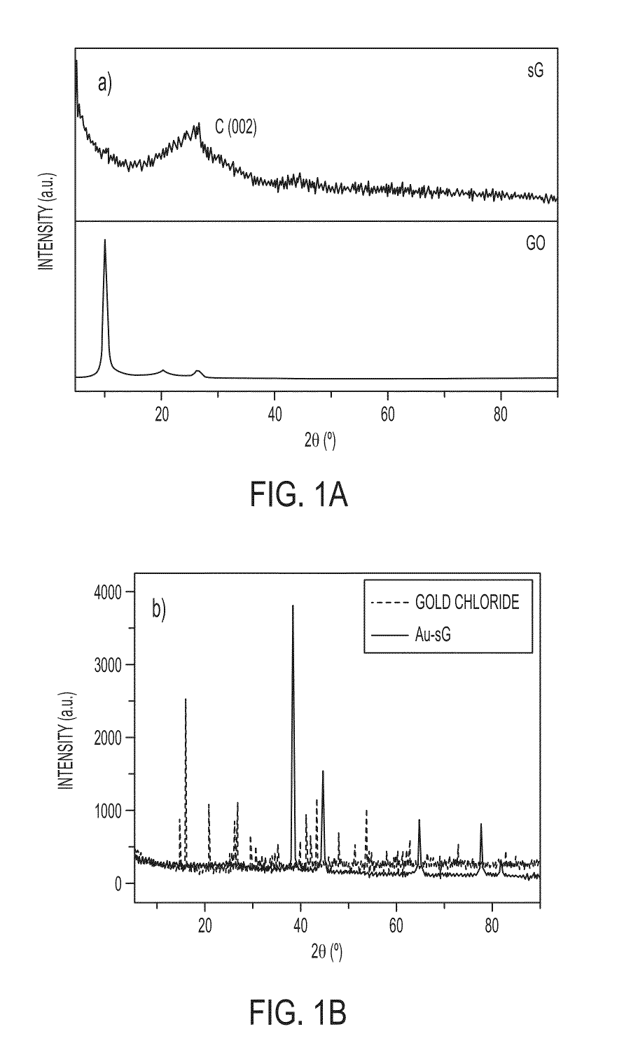

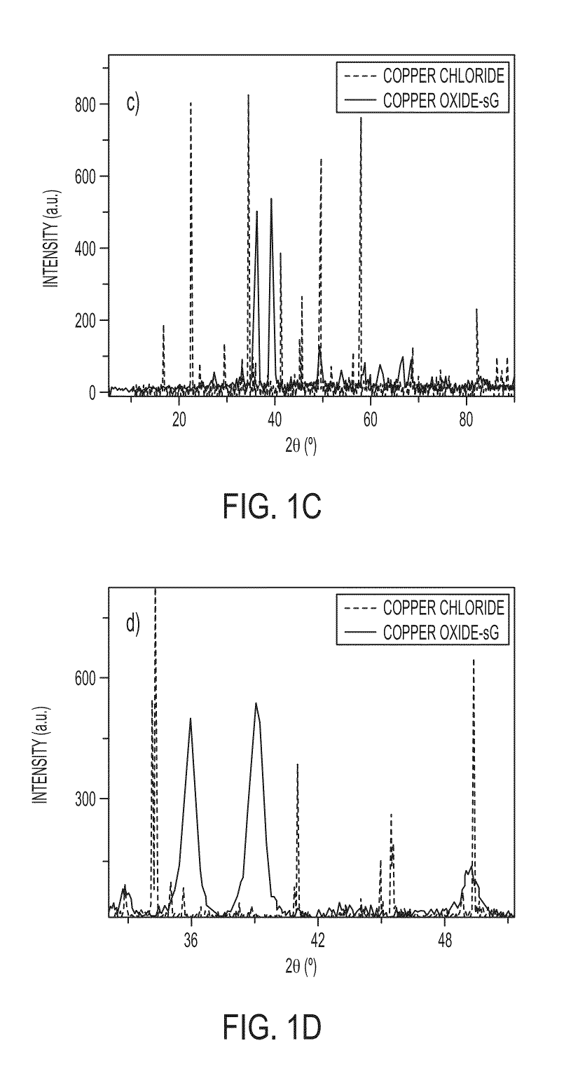

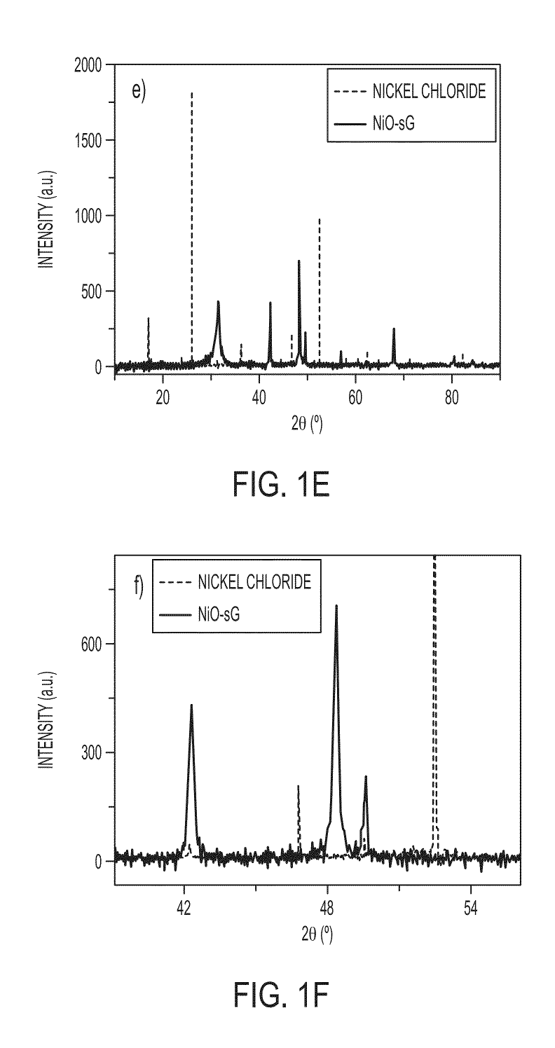

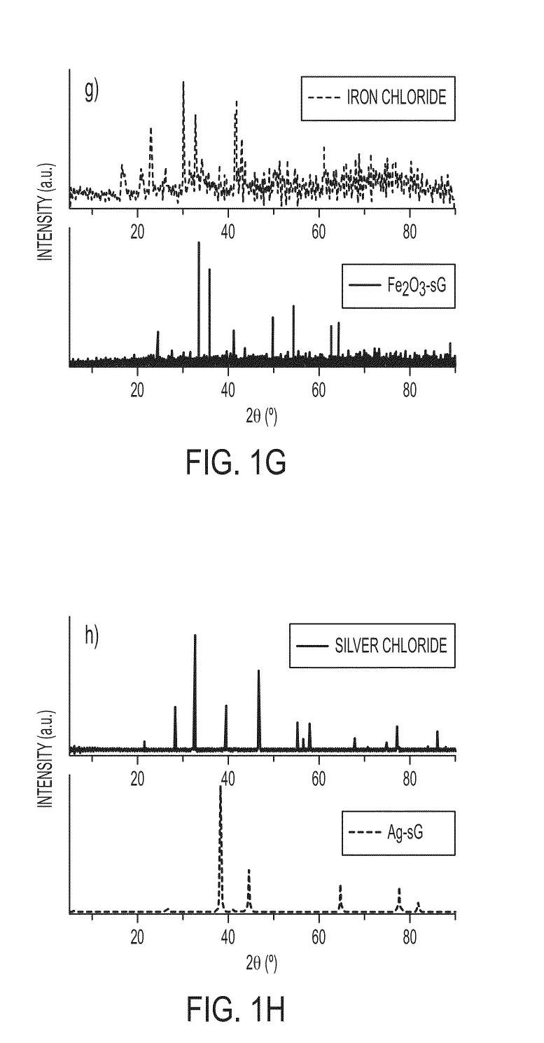

FIG. 1a shows the XRD of the graphite oxide where the inter layer spacing of the planes was 8.36 A°. It is observed that the focused sunlight brings back the interlaying spacing in sG to 3.34 A° [8] similar to that of graphite. This is evident from the shift in the position of C(002) peak. The XRD of several metal chloride salts show a number of peaks (FIGS. 1b-1h). After exposing the salt-GO composites to focused solar radiation, the salt peaks disappear due to the removal of chlorine from the salts probably due to thermal decomposition of chlorides. The XRD of Au/sG contains a broad peak at 26° corresponding to C(002) plane of graphene as well as the peaks corresponding to Au. Similarly FIGS. 1c-1h show the C(002) peak of graphene and peaks corresponding to CuO, NiO and Fe₂O₃. The structure and formation of the compounds have been analyzed and matches well with JCPDS for Au (65-2870), CuO (PCPDF: 89-5895), NiO (89-7131), Fe₂O₃ (PCPDF: 89-0598) and Ag (PCPDF: 89-3722). The enlarged view of the XRD of CuO/sG (FIG. 1d.) and NiO/sG (FIG. 1f.) clearly demonstrates the formation of crystal structure of corresponding metal oxides. Hence it is evident that metal salts and metal salt-GO composites can be reduced to their respective metals or metal oxides and metal/metal oxide/sG by simple irradiation of the composite with focused solar light.

The designation sG is used herein to denote graphene produced by solar exfoliation resulting in the reduction of graphite oxide to graphene. Other types of reduction maybe used, as described herein.

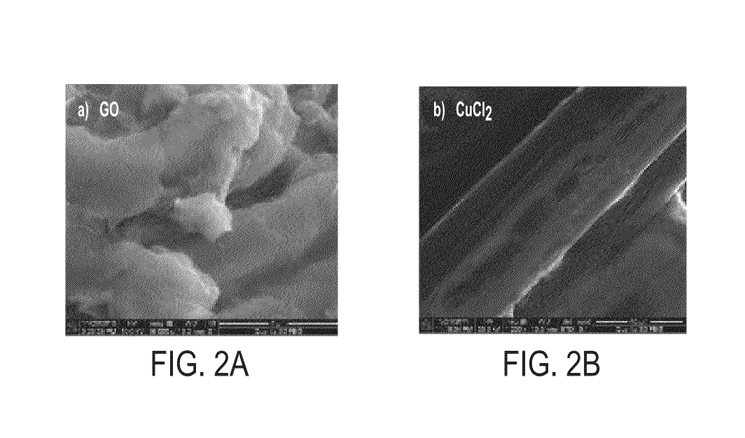

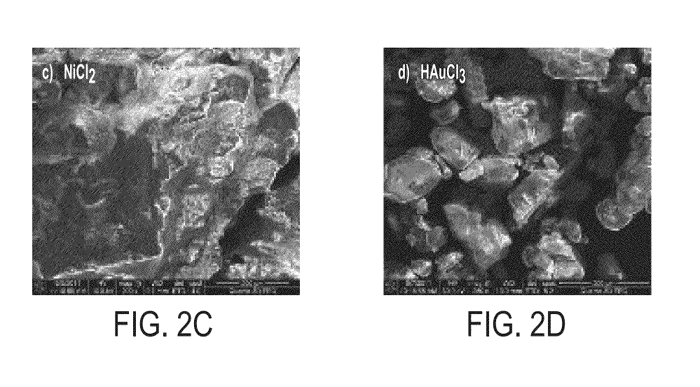

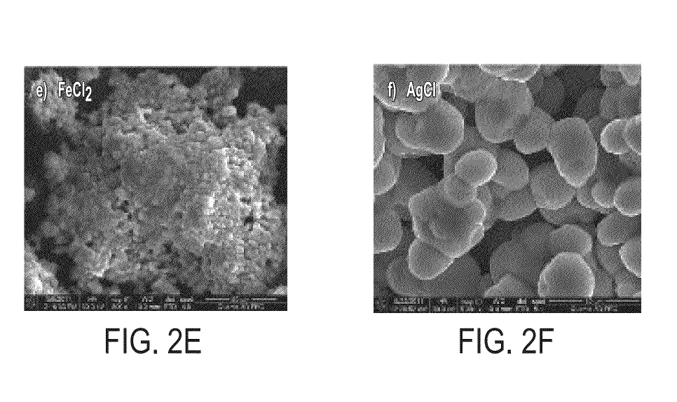

FIG. 2 shows the FESEM images of the starting materials, GO and various salts. The thick layers of GO, as evident in FIG. 2a, very clearly shows an agglomeration of several graphite oxide sheets. FESEM images of various salts displayed different morphology as depicted in FIGS. 2b-2f. The particles are large in size and agglomerated.

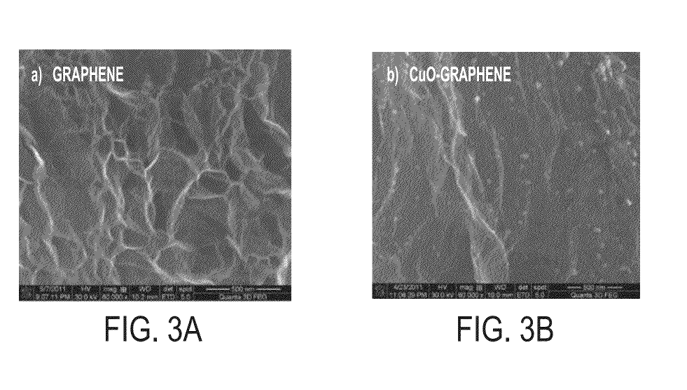

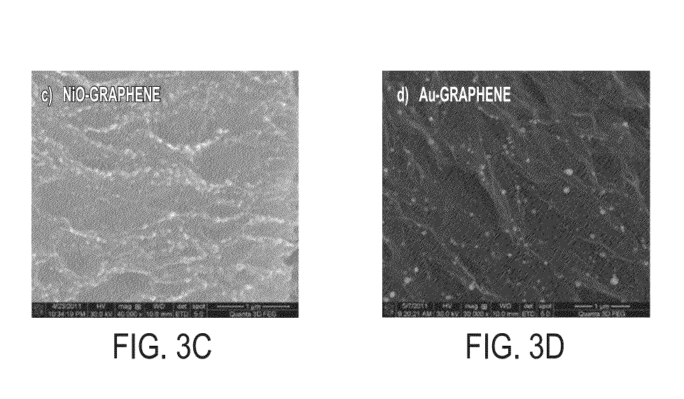

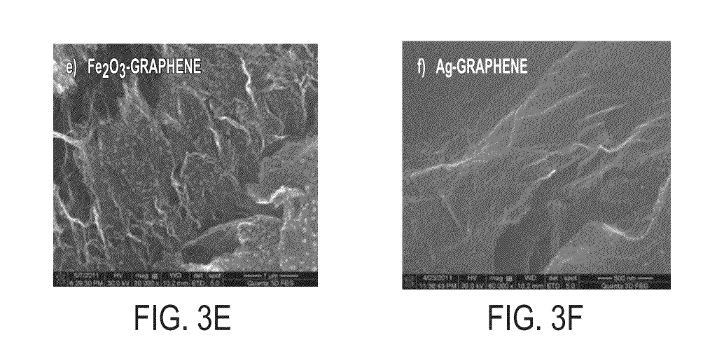

When the salts are loaded over GO to form a metal salt/GO composite and reduced under intensified electromagnetic radiation (e.g. focused solar radiation), a metal or metal oxide nanoparticles dispersed graphene composite results. The nanoparticles are several nanometers in diameter. Uniform dispersion of nanoparticles over the reduced graphene is observed. Furthermore, the FESEM images (FIGS. 3a-3f) give clear evidence for the separation of adjacent graphene sheets by nanoparticles. Also a coating of nanoparticles over both surfaces of a graphene sheet can be seen from the FESEM images. These could act as spacers to prevent the restacking of graphene sheets.

EDX spectra of metal salts, as well as GO, before and after reduction have been recorded for the quantification of chlorine present in the materials. The chlorine content in the metal salts and reduced metals and/or the oxygen content in the GO or reduced metal oxide/graphene can be used to evaluate whether the reduction is complete. Original chlorine levels vary depending on the salt and are given in Table 1 below. The oxygen content in GO is about 30 at %. The EDX spectra of different metal salts demonstrated the presence of both metal as well as chlorine. The EDX spectra of the reduced products, graphene and the metal or metal oxide-graphene nanocomposite are summarized in the tables below. The atomic % of chlorine present in the salts before and after reduction by focused solar radiation shows that irradiating with focused solar radiation can remove almost all chlorine present in the metal salts.

TABLE 1
Comparison of atomic % of chlorine before and after focused solar
irradiation in metal salts.

| | |
|---|---|
| Before focused solar radiation | After focused solar radiation |

| Metal salt | Chlorine (at %) | Chlorine (at %) |
|---|---|---|
| NiCl₂ | 58.6 | about 1 |
| AuCl₃ | 76.5 | about 0.66 |
| CuCl₂ | 68.1 | about 0.5 |
| FeCl₂ | 64.98 | about 0 |
| AgCl | 48.4 | about 0 |

EDX spectra of the metal/metal oxide/graphene composite materials reveal the efficient reduction of the metal salt-GO under focused solar radiation (Table 2). The oxygen present in solar graphene after exfoliation is nearly 3.9%. Oxygen quantification has been tabulated to demonstrate the extent of reduction of GO in metal salt-GO composites. The negligible amount of oxygen and chlorine present in the reduced metal-sG composites corroborates the idea of simultaneous reduction of metal salts and GO.

TABLE 2
Comparison of chlorine and oxygen in metal/metal oxide/graphene
composites after being exposed to focused solar radiation.
After focused solar irradiation

| Metal-graphene | Chlorine (at %) | Oxygen (at %) |
|---|---|---|
| CuO-graphene | about 0.4 | 2.9 |
| Au-graphene | about 1 | 3 |
| NiO-graphene | about 1.2 | about 7 |
| Fe₂O₃-graphene | about 0.9 | about 10 |
| Ag-graphene | about 0 | about 4 |

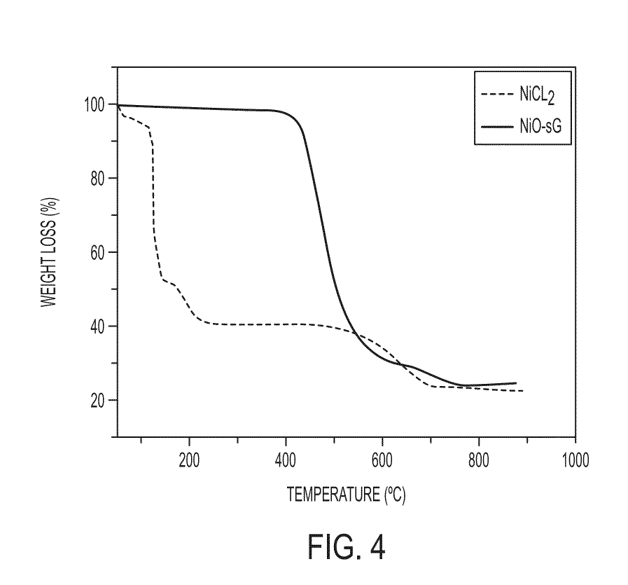

In order to quantify the weight percentage of nanoparticles over graphene, thermo gravimetric analysis (TGA) of one of the samples has been depicted in FIG. 4. FIG. 4 shows the TGA curves of NiCl₂ as well as for NiO-graphene nanocomposite. For NiCl₂, at 116° C., 7 wt % losses have been observed and at 144° C., the weight loss is about 48%. Finally, about 63% loss in weight is observed at 550° C. NiO-sG on the other hand exhibits about 2 wt % loss at 300° C. and the onset decomposition temperature is about 400° C. Nearly 20 wt % loading of Ni has been obtained. Hence it is evident from the TGA curves of metal salts and metal dispersed sG that the decomposition of metal/sG occurs at higher temperature than that of pure metal salts. This corroborates the removal of chlorine from the metal salt-GO composites during reduction.

### Example 3

### Au-Graphene

Because it is biocompatible as well as biodegradable Au-graphene can be used in biomedical applications such as targeted drug delivery, bio imaging as well as in biosensors.

### Example 4

### FE₂O₃-Graphene

Fe₂O₃-graphene can be used as flexible magnetic absorbers in space applications for dissipation of electromagnetic interference as well as in hydrogen peroxide sensing and water purification.

### Example 5

### NIO-Graphene

NiO-graphene can be used as excellent anode material in batteries.

### Example 6

### Energy Conversion

The synergistic properties arising from combining graphene and metal/metal oxide nanoparticles make them suitable for energy conversion materials.

### Example 7

### Friction Reduction

Advanced tribological materials can be prepared which reduces friction between wear parts and absorbs the unwanted heat.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases one or more or at least one and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 substituents refers to groups having 1, 2, or 3 substituents. Similarly, a group having 1-5 substituents refers to groups having 1, 2, 3, 4, or 5 substituents, and so forth.

What is claimed is:

1. A method of making a metal/metal oxide nanoparticle dispersed graphene nanocomposite, the method comprising:
providing a substantially solid metal salt-graphite oxide composite; and
exposing the metal salt-graphite oxide composite to intensified electromagnetic radiation to form the metal/metal oxide nanoparticles dispersed graphene nanocomposite by reducing the metal salt to a metal or metal oxide and the graphite oxide to graphene.

2. The method of claim 1, wherein the electromagnetic radiation is selected from visible light, sunlight, simulated sunlight, a combination thereof, a selected portion thereof, or a combination of selected portions thereof intensified to suitable power.

3. The method of claim 1, wherein the intensified electromagnetic radiation provides about 0.65 W/cm²-1.95 W/cm².

4. The method of claim 1, wherein the intensified electromagnetic radiation causes a temperature increase to about 300° C. to about 400° C.

5. The method of claim 1, wherein, prior to the exposing step, the intensified electromagnetic radiation is provided by at least one of:
a) passing electromagnetic radiation through at least one refractile material;
b) passing the electromagnetic radiation through at least one converging lens; and
c) reflecting the electromagnetic radiation off of one or more converging mirrors.

6. The method of claim 1 wherein the exposing step is performed for no more than about 10 minutes per 100 mg of metal salt-graphite oxide composite.

7. The method of claim 1, wherein the metal salt-graphite oxide composite comprises a metal salt selected from iron salts, copper salts, nickel salts, gold salts, silver salts, platinum salts, palladium salts, cobalt salts, zinc salts, cerium salts and ruthenium salts, and combinations thereof.

8. The method of claim 1 wherein the metal salt-graphite oxide composite comprises a metal salt selected from halide salts, sulphate salts, acetate salts, and nitrate salts of iron, copper, nickel, gold, silver, platinum, palladium, cobalt, ruthenium and combinations thereof.

9. The method of claim 1, wherein the metal salt-graphite oxide composite comprises a metal salt selected from FeCl₂, CuCl₂, CoCl₂, NiCl₂, AgCl, HAuCl₂, HAuCl₄, AgNO₃, H₂PtCl₆, H₂PdCl₄, RuCl₂, Co(NO₃)₂, AgC₂H₃O₂, CuSO₄, FeSO₄, SnCl₂, ZnCl₂, (NH₄)₂Ce(NO₃)₆, CrCl₃, metal acetates and combinations thereof.

10. The method of claim 1, wherein the intensified electromagnetic radiation reduces the metal salt to a metal or metal oxide and the graphite oxide to graphene.

11. The method of claim 1, wherein the metal salt-graphite oxide composite comprises a metal salt selected from AgCl, HAuCl₄, HAuCl₂, HAuCl₄, AgNO₃, H₂PtCl₆, H₂PdCl₄, RuCl₂, SnCl₂, ZnCl₂, (NH₄)₂Ce(NO₃)₆, CrCl₃, and metal acetates, which is reduced to a corresponding metal selected from Ag, Au, Pt, Pd, Ru, Sn, Ce and Cr.

12. The method of claim 1, wherein the metal salt-graphite oxide composite comprises a metal salt selected from FeCl₂, CuCl₂, CoCl₂ NiCl₂, SnCl₂, ZnCl₂, (NH₄)₂Ce(NO₃)₆, and CrCl₃, which is reduced to a corresponding metal oxide selected from Fe₂O₃, CuO, CoO, NiO, SnO₂, ZnO, CeO₂, and CrO₂.

13. The method of claim 1, wherein the substantially solid metal salt graphite oxide composite is prepared by:
dispersing graphite oxide in a solvent to form a dispersion;
adding a metal salt to the dispersion; and
drying the resultant material to yield a substantially solid metal salt-graphite oxide composite.

14. The method of claim 13, wherein dispersing the graphite oxide in a solvent further comprises dispersing the graphite oxide in the solvent by ultrasonication.

15. The method of claim 13, wherein the solvent comprises water.

16. The method of claim 1, wherein the metal salt and graphite oxide are reduced simultaneously.

17. A nanocomposite comprising:
a graphene sheet; and
a plurality of nanoparticles of at least one metal or metal oxide dispersed on the graphene sheet.

18. The nanocomposite of claim 17, wherein the at least one metal or metal oxide is selected from Fe₂O₃, CuO, NiO, Au, Ag, Pt, Pd, Co, Ru, CoO, RuO₂, SnO₂, ZnO, CeO₂, CrO₂, and combinations thereof.

19. The nanocomposite of claim 17, wherein the graphene sheet defines two sides, and the nanoparticles of the at least one metal or metal oxide are dispersed substantially evenly on both the two sides of the graphene sheet.

20. The nanocomposite of claim 17, wherein the composition comprises a plurality of graphene sheets, each of which contains dispersed nanoparticles of at least one metal or metal oxide.

21. The nanocomposite of claim 17 wherein the plurality of nanoparticles are non-magnetic nanoparticles, magnetic nanoparticles or combinations of thereof.

22. The nanocomposite of claim 17, where the graphene sheet is coated with 10-15 nm Ag nanoparticles distributed in a face centered cubic structure of Ag.

23. The composition of claim 17, graphene sheets are coated with about 12-18 nm Au nanoparticles with face centered cubic structure.

24. The nanocomposite of claim 17, where the graphene sheet is coated with about 12-20 nm CuO nanoparticles, about 9-18 nm NiO nanoparticles, about 34-50 nm magnetic Fe₂O₃ nanoparticles, or combinations thereof.

25. The graphene nanocomposite of claim 17, wherein the nanocomposite comprises less than 2 at. % chlorine.

26. The nanocomposite of claim 17, wherein the nanoparticles are metals, and the oxygen content in the nanocomposite is less than about 7 at. %.

27. The nanocomposite of claim 17, wherein the nanoparticles are metal oxides, and the oxygen content in the nanocomposite is less than about 15 at. %.

28. The method of claim 4, wherein the temperature increase is at a rate of about 75° C. per second to about 200° C. per second.
